(19) United States
(12) Patent Application Publication
(10) Pub. No.: US 2026/0205175 A1
(43) Pub. Date: Jul. 16, 2026

(54) NON-PHASE ALIGNED MIMO TRANSMISSION

(71) Applicant: Telefonaktiebolaget LM Ericsson (publ), Stockholm (SE)

(72) Inventors: Joao VIEIRA, HJÄRUP (SE); Pål FRENGER, LINKÖPING (SE); Erik G. LARSSON, LINKÖPING (SE)

(73) Assignee: Telefonaktiebolaget LM Ericsson (publ), Stockholm (SE)

(21) Appl. No.: 19/135,647

(22) PCT Filed: Dec. 6, 2022
(86) PCT No.: PCT/EP2022/084544

§ 371 Date: Jun. 4, 2025

(51) Int. Cl. H04B 7/06; H04B 7/0413

(52) U.S. Cl. CPC H04B 7/0617; H04B 7/0413

(57) ABSTRACT

A method is disclosed for controlling multiple-input multiple-output (MIMO) transmission to a receiver device from two or more non-phase aligned transmitter devices, wherein each transmitter device is associated with a respective channel towards the receiver device. The method comprises selecting a respective beamforming setting for each of the transmitter devices, wherein the selection is conditioned on a metric of spatial separation among the respective beamforming settings as affected by the respective channels, and causing the transmitter devices to transmit respective data streams to the receiver device using the selected respective beamforming setting. In some embodiments, the selection is further conditioned on a respective power of the respective beamforming setting as affected by the respective channel. Corresponding computer program product, apparatus, control node, and distributed MIMO system are also disclosed.

The project leading to this application has received funding from the European Union's Horizon 2020 research and innovation programme under grant agreement No 101013425.

### TECHNICAL FIELD

The present disclosure relates generally to the field of wireless communication. More particularly, it relates to multiple-input multiple-output (MIMO) transmission from non-phase aligned transmitter devices.

### BACKGROUND

In some wireless communication approaches, two or more transmitter devices are used to simultaneously transmit to a receiver device. Then, geographic distribution of service antennas may be obtained, which can be beneficial for robustness and/or channel utilization.

For example, in distributed multiple-input multiple-output (D-MIMO; a.k.a. cell-free massive MIMO, Radio Stripes, Radio Weaves, etc.), a plurality of access points (APs) may be controlled such that a selected set of the APs collectively perform MIMO transmission to a user device (e.g., a user equipment, UE). Another example is multiple transmission point (multi-TRP) operation of a wireless communication network.

The operation of the two or more transmitter devices is preferable phase-coherent; i.e., the two or more transmitter devices are preferably phase aligned. Phase alignment among the transmitter devices enables joint coherent beamforming for transmission to the receiver device.

For example, an example D-MIMO architecture comprises multi-antenna panels (e.g., one panel per AP) interconnected and configured to cooperate phase-coherently. Additionally, an AP may comprise two or more antenna elements that are also configured to operate phase-coherently. Thus, all antenna elements of all of the APs together effectively form a large, coherently operating, antenna array.

Typically, phase alignment among the transmitter devices requires calibration protocols, which may entail drawbacks such as, for example, signaling overhead, computational complexity, and/or additional power consumption at the transmitter devices. Furthermore, the phase reference kept in each transmission device needs to be sufficiently stable, which may entail drawbacks such as, for example, increased implementation complexity and/or relatively high power consumption at the transmitter devices. Thus, phase alignment may be cumbersome; especially for relatively high carrier frequencies.

Therefore, there is a need for alternative approaches, where two or more non-phase aligned transmitter devices are used to simultaneously transmit to a receiver device.

Preferably, such approaches demonstrate improved performance compared to other approaches where non-phase aligned transmitter devices are used for transmission to a receiver device.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for controlling multiple-input multiple-output (MIMO) transmission to a receiver device from two or more non-phase aligned transmitter devices, wherein each transmitter device is associated with a respective channel towards the receiver device. The method comprises selecting a respective beamforming setting for each of the transmitter devices, wherein the selection is conditioned on a metric of spatial separation among the respective beamforming settings as affected by the respective channels, and causing the transmitter devices to transmit respective data streams to the receiver device using the selected respective beamforming setting.

In some embodiments, the metric of spatial separation comprises an achievable communication rate for the respective beamforming settings as affected by the respective channels.

In some embodiments, the metric of spatial separation comprises a respective inner product—for a pair of two of the transmitter devices—between the respective beamforming settings as affected by the respective channels.

In some embodiments, the selection is conditioned on the respective inner product—for one or more pair of two of the transmitter devices—having an absolute value that is lower than, or equal to, a threshold for inner product.

In some embodiments, the selection is further conditioned on a respective power of the respective beamforming setting as affected by the respective channel.

In some embodiments, the selection is conditioned on the respective power—for one of the transmitter devices—being higher than a threshold for respective power.

In some embodiments, the selection comprises (for each of the transmitter devices) determining a set of candidate beamforming settings, and selecting the respective beamforming setting as one of the candidate beamforming settings, or as a linear combination of two or more of the candidate beamforming settings.

In some embodiments, the set of candidate beamforming settings comprises one or more of: a specific number of beamforming settings, beamforming settings capturing a total power that is larger than a threshold for total power, and beamforming settings each capturing an individual power that is larger than a threshold for individual power.

In some embodiments, the set of candidate beamforming settings is selected from right singular vectors of a singular value decomposition of a matrix representation of the respective channel.

In some embodiments, selecting the respective beamforming settings comprises evaluating—for one or more pair of two of the transmitter devices—combinations of candidate beamforming settings based on the metric of spatial separation, and selecting the respective beamforming settings based on the evaluation.

In some embodiments, the selection of the respective beamforming settings comprises a trade-off between spatial separation among the respective beamforming settings and power of the respective beamforming settings.

In some embodiments, each of the transmitter devices is comprised in an access point of a distributed MIMO (D-MIMO) system.

In some embodiments, selecting the respective beamforming settings conditioned on the metric of spatial separation is responsive to the two or more transmitter devices being less than a specific number of transmitter devices.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for controlling multiple-input multiple-output (MIMO) transmission to a receiver device from two or more non-phase aligned transmitter devices, wherein each transmitter device is associated with a respective channel towards the receiver device. The apparatus comprises controlling circuitry configured to cause selection of a respective beamforming setting for each of the transmitter devices, wherein the selection is conditioned on a metric of spatial separation among the respective beamforming settings as affected by the respective channels. The controlling circuitry is also configured to cause the transmitter devices to transmit respective data streams to the receiver device using the selected respective beamforming setting.

A fourth aspect is aa control node comprising the apparatus of the third aspect.

A fifth aspect is a distributed MIMO (D-MIMO) system comprising a plurality of access points and the control node of the fourth aspect.

In some embodiments, any of the above aspects may additionally have features identical with or corresponding to any of the various features as explained above for any of the other aspects.

An advantage of some embodiments is that improved approaches are provided, for using two or more non-phase aligned transmitter devices to simultaneously transmit to a receiver device.

An advantage of some embodiments is that improved performance may be achieved compared to other approaches where non-phase aligned transmitter devices are used for transmission to a receiver device.

An advantage of some embodiments is that signaling overhead may be reduced compared to approaches where phase aligned transmitter devices are used for transmission to a receiver device.

An advantage of some embodiments is that complexity and/or power consumption of the transmitter devices may be reduced compared to approaches where phase aligned transmitter devices are used for transmission to a receiver device.

An advantage of some embodiments is that communication performance may be improved compared to other approaches where non-phase aligned transmitter devices are used for transmission to a receiver device. For example, improved communication performance may comprise one or more of: increased signal quality at the receiver (e.g., in terms of signal-to-noise ratio, SNR, signal-to-interference ratio, SIR, or any other suitable signal quality metric), decreased interference among transmissions from different transmitter devices, increased throughput, increased spectral efficiency, and increased energy efficiency.

An advantage of some embodiments is that no—or only minor—adaptions to the receiver device are needed to process the transmissions from the non-phase aligned transmitter devices.

An advantage of some embodiments is that the receiver device may process the transmissions from the non-phase aligned transmitter devices using relatively simple approaches (e.g., maximum-ratio combining, MRC).

An advantage of some embodiments is that complexity and/or power consumption of the receiver device may be reduced compared to other approaches where non-phase aligned transmitter devices are used for transmission to the receiver device. Particularly, when received data streams have orthogonal (or close to orthogonal) wave fronts, the receiver device can de-multiplex the data streams using simple spatial filters (e.g., maximum-ratio combining, MRC); thereby lowering complexity and/or power consumption compared to other approaches, with no (or very small) performance degradation.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a schematic drawing illustrating an example scenario according to some embodiments;

FIG. 3 is a plot illustrating example results achievable according to some embodiments;

FIG. 4 is a plot illustrating example results achievable according to some embodiments;

FIG. 5 is a schematic block diagram illustrating an example apparatus according to some embodiments;

FIG. 6 is a schematic block diagram illustrating an example D-MIMO system according to some embodiments;

FIG. 7 is a schematic drawing illustrating an example computer readable medium according to some embodiments;

FIG. 8 schematically illustrates a telecommunication network connected via an intermediate network to a host computer;

FIG. 9 is a generalized block diagram of a host computer communicating via a base station with a user equipment over a partially wireless connection; and

FIGS. 10 and 11 are flowcharts illustrating methods implemented in a communication system including a host computer, a base station, and a user equipment.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, approaches will be described and exemplified for multiple-input multiple-output (MIMO) transmission to a receiver device from two or more non-phase aligned transmitter devices. Some embodiments are particularly suitable for distributed multiple-input multiple-output (D-MIMO).

Generally, when a receiver device is referred to herein, it can comprise any suitable receiver device. For example, the receiver device may be comprised in a user device; such as a user equipment (UE) compliant with Third Generation Partnership (3GPP) standardization, or a station (STA) compliant with IEEE 802.11 standardization.

Also generally, when a transmitter device is referred to herein, it can comprise any suitable transmitter device. For example, the transmitter device may be comprised in a communication node; such as a transmission point (TRP) compliant with Third Generation Partnership (3GPP) standardization, an access point (AP) compliant with IEEE 802.11 standardization, or a D-MIMO access point. Generally, a communication node may comprise a single transmitter device, or may comprise two or more non-phase aligned transmitter devices.

It should be noted that, even though exemplification of the approaches focuses on geographically distributed transmitter devices, embodiments are equally applicable in scenarios with geographically co-located transmitter devices. For example, according to some embodiments, the approaches disclosed herein may be applied to situations where two or more transmitter devices are co-located (or even comprised within the same communication node) with respective antenna panels directed differently.

Furthermore, it should be noted that when a beamforming setting is referred to herein, it is meant to encompass any type of emission pattern that apply beamforming principles. For example, a beamforming setting may entail transmission of a single beam, or simultaneous transmission of two or more beams.

For simplicity, this disclosure uses examples wherein each D-MIMO AP is fully digital in the sense that each of its transceivers is associated with one, and only one, antenna element. However, it should be noted that the suggested approaches are equally applicable for antenna panels configured for analog beamforming, or hybrid beamforming.

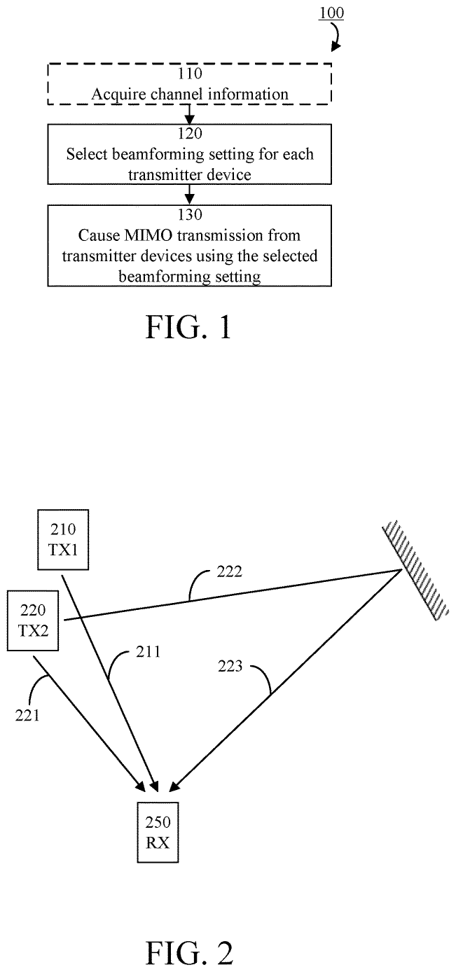

FIG. 1 illustrates an example method 100 according to some embodiments. The method 100 is for controlling MIMO transmission to a receiver device from two or more non-phase aligned transmitter devices. The method 100 may be performed by a control node; e.g., a control node of a D-MIMO system, or a control node of a multi-TPR deployment. The control node may be separate from each of the transmitter devices, or one or more of the transmitter devices may be comprised in the control node.

Each transmitter device is associated with a respective channel towards the receiver device. As illustrated by optional step 110, the method 100 may comprise acquiring channel information (e.g., channel state information, CSI) including the information indicative of the respective channels towards the receiver device. The channel information may be acquired in any suitable way; e.g., using a suitable approach according to the prior art. For example, step 110 may comprise performing channel measurements and/or channel estimation based on received reference signaling. Alternatively, step 110 may comprise receiving the channel information from another device (e.g., from the transmitter devices, or from the receiver device).

As illustrated by step 120, the method 100 comprises selecting a respective beamforming setting for each of the transmitter devices. The selection of step 120 is conditioned on a metric of spatial separation among the respective beamforming settings as affected by the respective channels. Thus, the selection comprises considerations involving a metric that is indicative of the spatial separation—as experienced at the receiver device—among signals transmitted by the transmitter devices using the respective beamforming settings. Typically, a relatively large spatial separation may be beneficial.

Generally, the expression “beamforming settings as affected by the respective channels” is used to denote the communication channels (G₁w₁, G₂w₂, etc.) that are generated by using the beamforming settings (w₁, w₂, etc.) in the context of the radio environment between the transmitter devices and the receiver device (G₁, G₂, etc.). In some embodiments, selecting the respective beamforming settings conditioned on the metric of spatial separation is responsive to the two or more transmitter devices being less than a specific number of transmitter devices.

Hence, the selection of respective beamforming setting for each of the transmitter devices may be conditioned on the metric of spatial separation only when there are between two and an upper threshold value of transmitter devices, and any other suitable selection approach (e.g., a selection approach according to the prior art) may be applied for other situations. The upper threshold value may, for example, be set to two, three, four, or five.

This approach may be motivated when the performance improvement achieved by selecting the respective beamforming settings conditioned on the metric of spatial separation decreases when the number of transmitter devices increases, and/or when a cost (e.g., in terms of one or more of: computational complexity, power consumption, latency, coordination among transmitter devices, etc.) associated with selecting the respective beamforming settings conditioned on the metric of spatial separation increases when the number of transmitter devices increases.

As illustrated by step 130, the method 100 also comprises causing the transmitter devices to transmit respective data streams to the receiver device using the selected respective beamforming setting. For a transmitter device comprised in a control node performing the method 100, step 130 may comprise transmitting the respective data stream(s) of the transmitter device using the selected respective beamforming setting. For a transmitter device which is separate from a control node performing the method 100, step 130 may comprise transmitting control signaling to the transmitter device, wherein the control signaling is configured to cause the transmitter device to transmit the respective data stream(s) of the transmitter device using the selected respective beamforming setting.

The transmission, from a transmitter device, of the respective data stream(s) may be performed according to any suitable approach (e.g., any suitable MIMO transmission approach of the prior art). For example, transmission of a respective data stream may be implemented by a layer of a MIMO transmission according to the 3GPP standardized New Radio (NR) for fifth generation (5G) communication.

The receiver device may use any suitable approach for separation of the data streams of the MIMO transmission. For example, the receiver device may apply reception beamforming corresponding to the transmission beamforming to separate the data streams; e.g., according to zero-forcing (ZF) beamforming, or matched filter beamforming.

Some further exemplification will now be given for the selection, in step 120, of the respective beamforming settings for the transmitter devices conditioned on the metric of spatial separation among the respective beamforming settings as affected by the respective channels.

The term spatial separation may be interpreted in any suitable way. For example, a large spatial separation may comprise a large difference in (e.g., close to orthogonal) angle of arrival at the receiver device. More generally, a large spatial separation may refer to a situation with received signals that are highly separable by the receiver. For a situation with two or more downlink channels, where a downlink channel comprises the respective beamforming setting applied at the corresponding transmitter device, a large spatial separation may comprise that any pair of two of the downlink channels are (close to) orthogonal: i.e. that the inner product between the two downlink channels is (close to) zero.

According to some embodiments, the selection of the respective beamforming settings is conditioned on the metric of spatial separation having a value that falls on a specific side of a threshold for spatial separation; wherein the specific side of the threshold for spatial separation is indicates larger spatial separation than the other side of the threshold for spatial separation.

The metric of spatial separation may be any suitable metric that indicates spatial separation among the respective beamforming settings as affected by the respective channels.

For example, the metric of spatial separation may comprise an inner product between respective beamforming settings as affected by the respective channels; typically a respective inner product for each pair of two of the transmitter devices. In some embodiments, the inner product is normalized. Alternatively or additionally, the absolute value of the inner product may be used. When the inner product is normalized, the normalization may be in relation to the product of the lengths (norms) of vectors that represent the respective beamforming settings. Thereby, the normalized inner product is in the interval [−1 . . . 1]; or in the interval [0 . . . 1] when the absolute value of the inner product is used.

Generally, all references to “inner product” are meant to encompass—as suitable—the inner product, the normalized inner product, the absolute value of the inner product, and the absolute value of the normalized inner product.

According to some embodiments, the selection of the respective beamforming settings is conditioned on the respective inner product—for one or more (e.g., each) pair of transmitter devices—having an absolute value that is lower than, or equal to, a threshold for inner product. Thus, the selection may be conditioned on that at least some (e.g., all) of the data streams are close to orthogonal at the receiver device. The threshold for inner product may have any suitable value; e.g., zero or slightly higher than zero, such as a value in the interval ] 0,0.1].

In some embodiments, the selection in step 120 is further conditioned on a respective power of the respective beamforming setting as affected by the respective channel. Thus, the selection may comprise considerations involving the respective power—as experienced at the receiver device—of signals transmitted by the transmitter devices using the respective beamforming settings. Typically, a relatively high received power may be beneficial. Generally, a relatively high transmitted power may be needed to achieve a relatively high received power.

According to some embodiments, the selection of the respective beamforming settings is conditioned on the respective power (transmitted and/or received)—for one or more (e.g., each) of transmitter devices—having a value that is higher than a threshold for respective power. The threshold for respective power may have any suitable value. For example, the threshold for respective power may correspond to the lowest transmission power that enables acceptable communication performance between the transmitter device and the receiver device in terms of some suitable communication quality metric (e.g., error rate, retransmission rate, throughput, SIR, etc.).

In some embodiments, the selection of the respective beamforming settings in step 120 comprises a trade-off between (large) spatial separation among the respective beamforming settings and (high) power of the respective beamforming settings. For example, step 120 may comprise selecting the respective beamforming settings such that a joint condition for power and spatial separation is fulfilled. In some approaches, step 120 comprises selecting the respective beamforming settings such that a spatial separation condition is fulfilled under some power constraint, or vice versa.

In some approaches, the metric of spatial separation is also a metric for (transmitted and/or received) power. Then, letting the selection in step 120 be conditioned on the metric of spatial separation having a value that falls on a specific side of a threshold for spatial separation may represent a trade-off between (large) spatial separation among the respective beamforming settings and (high) power of the respective beamforming settings.

For example, the metric of spatial separation may comprise an achievable communication rate for the respective beamforming settings as affected by the respective channels. Such a metric depends on the powers for the respective beamforming settings, as well as on the inner product between pairs of respective beamforming settings as affected by the respective channels.

Regardless of the condition(s) to be fulfilled, the selection in step 120 may be an optimal selection, or a selection that is non-optimal (but—preferably—good enough). An optimal selection may comprise beamforming settings that achieve highest possible total rate, and/or have highest (respective and/or total) power, and/or have largest possible spatial separation (e.g., lowest possible value for cumulative inner product). A good enough selection may comprise beamforming settings that achieve a rate above a threshold for rate, and/or have a (respective and/or total) power above a threshold for power, and/or have a metric of spatial separation that falls on a specific side of a threshold for spatial separation (e.g., respective inner products below a threshold for inner product).

An exhaustive search among all possible beamforming settings may achieve optimal selection, while a search that is terminated when a stopping criterion is fulfilled may typically achieve a non-optimal selection. The stopping criterion may, for example, comprise that a specified number of possible beamforming settings have been explored and/or that beamforming settings have been found that are regarded as good enough.

According to some approaches, the selection in step 120 comprises (for each of the transmitter devices) determining a set of candidate beamforming settings and selecting the respective beamforming setting as one of the candidate beamforming settings, or as a linear combination of two or more of the candidate beamforming settings.

Selecting the respective beamforming settings may comprise evaluating (for one or more—typically each—pair of transmitter devices, or for all transmitter devices together) combinations of candidate beamforming settings based on the metric of spatial separation (and possibly also based on the power), and selecting the respective beamforming settings based on the evaluation. For example, a combination may be selected which has—among the evaluated combinations, or among the evaluated combinations which fulfil some power condition—highest total rate and/or largest spatial separation (e.g., lowest cumulative inner product).

The set of candidate beamforming settings may be any suitable set of beamforming settings; typically selected among the possible beamforming settings for the transmitter device under consideration.

For example, the set of candidate beamforming settings may comprise (e.g., consist of) a specific number of beamforming settings. The specific number may be fixed/pre-determined number, tunable, or dynamically varying. For example, the specific number may be lowered to reduce the cost (e.g., in terms of one or more of: computational complexity, power consumption, latency, etc.) associated with the selection.

Alternatively or additionally, the set of candidate beamforming settings may comprise (e.g., consist of) beamforming settings that capture a total (transmitted and/or received) power that is larger than a threshold for total power. For example, the threshold for total power may be expressed as a portion of a maximum possible total power.

Yet alternatively or additionally, the set of candidate beamforming settings may comprise (e.g., consist of) beamforming settings, which each captures an individual power that is larger than a threshold for individual power. The set of candidate beamforming settings may comprise (e.g., consist of) all such beamforming settings, or a sub-set thereof.

Yet alternatively or additionally, the set of candidate beamforming settings may comprise (e.g., consist of)—or correspond to—channel modes of the respective channel. Examples of a channel mode includes a channel path, or a combination of channel paths.

Yet alternatively or additionally, the set of candidate beamforming settings may be selected from right singular vectors of a singular value decomposition of a matrix representation of the respective channel for the transmitter device under consideration, or a linear combination of such right singular vectors. Typically, the right singular vectors may be determined/updated when the channel changes. In some embodiments, the determination/updating comprises computing the right singular vectors. In some embodiments, the determination/updating comprises retrieving the right singular vectors corresponding to the current channel from a collection of pre-computed right singular vectors corresponding to a corresponding collection of channels.

Yet alternatively or additionally, the set of candidate beamforming settings may be selected from columns of a discrete Fourier transform (DFT) matrix.

According to some examples, the set of candidate beamforming settings may comprise (e.g., consist of) a specific number of beamforming settings, selected from the right singular vectors of a singular value decomposition of a matrix representation of the respective channel.

Alternatively or additionally, the set of candidate beamforming settings may comprise (e.g., consist of) right singular vectors of a singular value decomposition of a matrix representation of the respective channel, which captures individual powers that larger than a threshold for individual power and/or total power larger than a threshold for total power.

As already mentioned, phase alignment among the transmitter devices may be cumbersome.

On the other hand, when two or more non-phase aligned transmitter devices are to cooperate in transmission to a receiver device, joint coherent beamforming is generally not possible.

One way to address this problem is to let the non-phase aligned transmitter devices transmit independent data streams (e.g., selecting beamforming settings according to the respective dominant singular channel vectors) and rely on multi-antenna processing at the receiver device for separation of the data streams. However, as will be exemplified in connection with FIG. 2, there are scenarios where both data streams, thus beamformed, arrive at the receiver device with similar angle of arrival (e.g., if the strongest paths from both transmitter devices are reflected by a same object before arriving at the receiver device). An attempt by the receiver device (e.g., using zero-forcing, ZF) to separate such data streams with similar angle of arrival typically leads to considerable noise enhancement, which may render the multi-stream transmission substantially useless. The approaches suggested herein offers better ways to address the problem of non-phase aligned transmitter devices.

Some further exemplification of the suggested approaches will now be presented, where a scenario with two transmitter devices (each with M antennas) are used for illustration. It should be noted that the presented principles are extendable to scenarios with more than two transmitter devices, and/or where one or more of the transmitter devices has a different number of antennas.

According to the exemplification the two transmitter devices are APs of a D-MIMO system, and the receiver device is a multi-antenna UE (with N antennas). The respective N×M channels from the APs to the UE are denoted G₁ and G₂, and each of the two APs transmits a data stream in the downlink.

The transmission of each AP is beamformed by a beamforming vector, and the two beamforming vectors (beamforming settings) w₁, w₂ are jointly selected such that the respective powers of the two received data streams are relatively large, and such that the spatial separation for the two received data streams is relatively large (e.g., such that the normalized inner product

$${w}_{1}^{H} {G}_{1}^{H} {G}_{2} {w}_{2}$$

between the spatial signatures of the two received data streams is relatively small-zero in theory, zero or very small in practice). For example, the respective powers of the two received data streams (transmitted powers ∥w₁∥², ∥w₂∥² or received powers ∥G₁w₁∥², ∥G₂w₂∥²) may be larger than a threshold for respective power, and the normalized inner product between the spatial signatures of the two received data streams may be lower than a threshold for inner product.

Thereby, significant noise enhancement due to UE processing with spatial filtering may be avoided (or at least reduced compared to other approaches).

A geometrical exemplification of a small normalized inner product is an angle of arrival between two signaling paths that is close to 90 degrees. More generally, a geometrical exemplification of a small normalized inner product is an angle of arrival between the spatial signatures of two received data streams that is large.

Some different examples for providing (with varying complexity) beamforming vectors with the above properties are presented herein. Since phase-alignment is not required, overhead signaling may be significantly reduced compared to phase-aligned approaches.

According to various examples, it is seen that spectral efficiency and/or energy efficiency may be obtained for non-phase aligned transmission of multiple data streams from multiple APs to a multi-antenna UE, by using the suggested approaches. In some situations, the suggested approaches perform very close to information theory limits. Approaches performing close to, or on, information theory limits are exemplified later herein by a successive interfering cancelation (SIC) approach. Compared with the SIC approach, the suggested approaches have considerably lower computational complexity, and are transparent to the receiver device.

In the following analysis, and in the numerical examples, it is assumed that N≤M, but it should be noted that the suggested approaches are applicable also when N>M. It is also assumed that G₁ and G₂, relative to the respective phase reference at each AP, are known with sufficient accuracy (compare with step 110 of FIG. 1). The operating signal-to noise ratio (SNR) is associated with transmit power, and is denoted by p.

Downlink beamforming with phase-aligned access points will be used as one (first) benchmark. This benchmark setup comprises two phase-aligned APs configured to operate coherently together and effectively form an array with 2M antenna elements. The capacity for this benchmark is generally not achievable for the approaches suggested for non-phase aligned APs, but may serve as an upper bound on performance. For this benchmark, there effectively is a point-to-point MIMO channel with channel matrix G=[G₁, G₂] of dimension N×2M. The covariance matrix of the transmitted signal is denoted by Q=[Q₁₁, Q₁₂; Q₂₁, Q₂₂] and each AP is subject to a transmit power constraint Tr(Q₁₁)≤1 and Tr(Q₂₂)≤1, where Tr(·) represents the trace of a matrix. The capacity is obtained by maximizing log₂|1+ρGQG^{H}| subject to the two power constraints. The maximization can be provided numerically using software packages for convex optimization, for example. The rank of the optimal Q represents the amount of independently coded streams that the 2M-element array formed by the two APs should transmit.

Downlink beamforming with non-phase aligned access points will be used for other benchmarks. In this case, joint coherent transmission is generally not possible; i.e. the 2M×N channel constituted by G₁ and G₂ should not be considered as a point-to-point channel. However, several transmission schemes are possible for this benchmark case.

In one non-phase aligned transmission scheme, used as a (second) benchmark, only one of the APs is operated, and the capacity corresponds to

$${max}_{i = 1 , 2} ( {max}_{{Q}_{i}} {log}_{2} \vert I + ρ {G}_{i} {Q}_{i} {G}_{i}^{H} \vert )$$

subject to Tr(Qᵢ)≤1. A drawback of this transmission scheme is that only one of the APs contributes.

For example, only one data stream can typically be transmitted when there is a line-of-sight channel to the UE.

In another non-phase aligned transmission scheme, used as a (third) benchmark, the two APs transmit independently coded data with respective covariance Q₁ and Q₂, and the UE applies successive interference cancellation (SIC) decoding. Thus, the UE may decode the data stream from the first AP while treating the transmission from the second AP as additive noise, subtract the first AP data stream from the received signal, and decode the data stream from the second AP. The capacity is given by

$${max}_{{Q}_{1} , {Q}_{2}} {log}_{2} \vert I + ρ {G}_{1} {Q}_{1} {G}_{1}^{H} + ρ {G}_{2} {Q}_{2} {G}_{2}^{H} \vert$$

subject to Tr(Q₁)≤1, Tr(Q₂)≤1. A drawback of this transmission scheme is that SIC typically entails complicated signal processing that suffers from error propagation.

The suggested approaches will now be exemplified for downlink beamforming with non-phase aligned access points. The beamforming selection (compare with step 120 of FIG. 1) provides for improved MIMO transmission (compare with step 130 of FIG. 1) where the first AP applies a beamforming vector w₁ and the second AP applies beamforming vector w₂. The beamforming vectors may be subject to power constraints according to ∥w₁∥²≤1 and ∥w₂∥²≤1.

The two effective channels from the APs to the UE are denoted as G₁w₁ and G₂w₂, and the N×2 matrix H=[G₁w₁, G₂w₂] represents the combined channel between the APs and the UE. Using zero-forcing processing, the UE may multiply the received N-dimensional signal by (H^{H} H)⁻¹H^{H}, which yields a representation of the two data streams.

The SNR per stream is

$$ρ / {σ}_{i}^{2} ,$$

i=1, 2, where

$${σ}_{i}^{2} = {[ {( {H}^{H} H )}^{- 1} ]}_{ii} ,$$

are the diagonal elements of the inverse of

$${H}^{H} H = [ {w}_{1}^{H} {G}_{1}^{H} {G}_{1} {w}_{1} , {w}_{1}^{H} {G}_{1}^{H} {G}_{2} {w}_{2} ; {w}_{2}^{H} {G}_{2}^{H} {G}_{1} {w}_{1} , {w}_{2}^{H} {G}_{2}^{H} {G}_{2} {w}_{2} ] .$$

It should be noted that the transmitted powers are representable by ∥ w₁∥², ∥w₂∥², the received powers are representable by ∥G₁w₁∥², ∥G₂w₂∥², and the inner product between the respective beamforming settings as affected by the respective channels is representable by

$${w}_{1}^{H} {G}_{1}^{H} {G}_{2} {w}_{2}$$

(or equivalently by

$${w}_{2}^{H} {G}_{2}^{H} {G}_{1} {w}_{1} ) .$$

Thus, the SNR per stream includes representations of power as well as inner product and may be used as a metric of spatial separation.

Explicitly, the SNRs of each stream are representable by

$$\frac{ρ}{{σ}_{i}^{2}} = ρ \frac{{w}_{1}^{H} {G}_{1}^{H} {G}_{1} {w}_{1} \cdot {w}_{2}^{H} {G}_{2}^{H} {G}_{2} {w}_{2} - {\vert {w}_{1}^{H} {G}_{1}^{H} {G}_{2} {w}_{2} \vert}^{2}}{{w}_{i}^{H} {G}_{i}^{H} {G}_{i} {w}_{i}} .$$

When the streams are independently coded the total rate becomes

$${\sum }_{i = 1 , 2} {log}_{2} ( 1 + \frac{ρ}{{σ}_{i}^{2}} ) ,$$

and when the streams are encoded using the same channel code and combined coherently in signal space (Chase combining) the total rate becomes

$${log}_{2} ( 1 + \frac{ρ}{{σ}_{1}^{2}} + \frac{ρ}{{σ}_{2}^{2}} ) ,$$

which can never exceed the rate for independent coding. Thus, the achievable total rate includes representations of power as well as inner product and may be used as a metric of spatial separation.

In yet another non-phase aligned transmission scheme, used as a (fourth) benchmark, the beamforming vectors w₁ and w₂ are selected as the dominant right singular vectors of G₁ and G₂, respectively. This approach maximizes the SNRs of each of the received streams, but may perform very poorly in some scenarios. This is because the incoming streams, as seen from the UE, may be cumbersome to separate (due to poor spatial separation).

FIG. 2 schematically illustrates an example scenario according to some embodiments. In the illustrated scenario, two transmitter devices (TX1, TX2) 210, 220 are configured for MIMO transmission to a receiver device (RX) 250.

Each transmitter device is associated with a respective channel towards the receiver device. The channel from TX1 to RX enables a direct transfer path 211, and a beamforming setting that matches the direct transfer path 211 could be selected for TX1. The channel from TX2 to RX enables a direct transfer path 221 as well as a transfer path 222, 223 comprising a reflection.

In many situations, the direct transfer path 221 has less attenuation than the reflected transfer path 222, 223, and a beamforming setting that matches the direct transfer path 221 could be selected for TX2. However, as perceived at RX, the spatial separation (here illustrated in the form of difference in angle of arrival) between the transfer path 211 from TX1 and the transfer path 221 from TX2 is relatively small, while the spatial separation between the transfer path 211 from TX1 and the reflected transfer path 222, 223 from TX2 is relatively large. Therefore, it may be beneficial to select a beamforming setting that matches the reflected transfer path 222, 223 for TX2.

Thus, the schematic illustration of FIG. 2 may be seen as a simplistic motivation for letting the selection of beamforming settings for MIMO transmission be conditioned on a metric of spatial separation among the respective beamforming settings as affected by the respective channels.

The scenario of FIG. 2 will be used later herein to illustrate performance the fourth benchmark and of the suggested approaches. Then, the APs and the UE have uniform half-wavelength-spaced linear arrays with M=16 and N=2. The propagation channel 211 from TX1 to RX is a rank-one channel (G₁=g₁x^{H} for some unit-norm vectors g₁ and x) generated according to a line-of-sight geometry. The propagation channel from TX2 to RX comprises a line-of-sight path 221 plus one multipath component 222, 223 (G₂=g₂y^{H}+αfz^{H} for some unit-norm vectors g₂, y, f, z, where α is an arbitrary, complex-valued, scalar constant). The path 211 departs from TX1 at an angle of 30 degrees (relative to the array boresight) and arrives at RX at an angle of 45 degrees (relative to the array boresight). The path 221 departs from TX2 at an angle 45 degrees (relative to the array boresight) and arrives at RX at an angle of 54 degrees (relative to the array boresight). Thus, the arrival angles of 211 and 221 differ by only 9 degrees. The path 222, 223 (with relative amplitude of α=0.7; i.e., 3 dB weaker than 221) departs from TX2 at an angle 0 degrees (relative to the array boresight) and arrives at RX at an angle of 0 degrees (relative to the array boresight).

The disclosed approaches suggest non-phase aligned transmission schemes where the beamforming vectors w₁ and w₂ are not necessarily selected as the dominant right singular vectors of G₁ and G₂. Rather, the two beamforming vectors w₁, w₂ are jointly selected and the selection is conditioned on a metric of spatial separation among the respective beamforming settings as affected by the respective channels. For example, the selection may aim for a trade-off between relatively large respective powers of the two received data streams, and a relatively small inner product between the spatial signatures of the two received data streams.

For example, the two beamforming vectors w₁, w₂ may be jointly selected by maximizing the total rate (e.g., according to the previously mentioned expressions for total rate) under some stipulated power constraint. This can be a relatively complicated approach. Two less complex approaches are presented below as “Approach A” and “Approach B”.

### Approach A

The singular value decompositions of G₁ and G₂ are represented as

$${G}_{1} = {U}_{1} {Δ}_{1} {V}_{1}^{H} and {G}_{2} = {U}_{2} {Δ}_{2} {V}_{2}^{H} ,$$

respectively, where

$${U}_{l} = [ {u}_{l}^{1} , … , {u}_{l}^{N} ] , {V}_{l} = [ {v}_{l}^{1} , … , {v}_{l}^{M} ] , {U}_{l}^{H} {U}_{l} = I , {V}_{l}^{H} {V}_{l} = I and$$

$${Δ}_{l} = Diag ( {δ}_{l}^{1} , … , {δ}_{l}^{N} )$$

for l=1, 2, and the dominant parts of the right singular space of G₁ and G₂ may be defined as the subspace of the channel that contains approximately a fraction t of the total channel energy, where 0<t<1 may be a pre-determined constant (e.g., t=0.75). Particularly, when dₗ is the smallest integer such that

$${\sum }_{n = 1}^{{d}_{l}} {δ}_{l}^{n} > t {\sum }_{n = 1}^{N} {δ}_{l}^{n} ,$$

the subspaces may be defied by

$$[ {v}_{1}^{1} , … , {v}_{1}^{{d}_{1}} ] and [ {v}_{2}^{1} , … , {v}_{2}^{{d}_{2}} ] ,$$

respectively for l=1, 2.

For example, an exhaustive search may be performed by considering all d₁d₂ vector pairs of one vector from

$$\{ {v}_{1}^{1} , … , {v}_{1}^{{d}_{1}} \}$$

and one vector from

$$\{ {v}_{2}^{1} , … , {v}_{2}^{{d}_{2}} \} ,$$

an evaluating the total rate (e.g., according to the previously mentioned expressions for total rate) if the pair of vectors was to be used as beamforming vectors w₁, w₂. Then, the pair of vectors that correspond to the highest rate may be selected.

Alternatively, a non-exhaustive search may be performed by considering only some of the above vector pairs (e.g., starting with those corresponding to highest total power) in a similar manner. The search may continue until a maximum number of pairs have been evaluated, or until an acceptable total rate (e.g., larger than a threshold for rate) has been found.

### Approach B

The selection of the beamforming vectors w₁, w₂ aim for inter-stream orthogonality and high received power for each data stream.

Regarding inter-stream orthogonality, the precoders w₁ and w₂ should preferably be selected so that the cost function

$$J ( {w}_{1} , {w}_{2} ) = {\vert {w}_{1}^{H} {G}_{1}^{H} {G}_{2} {w}_{2} \vert}^{2}$$

is minimized (or at least below a threshold for cost function). Thus, at the receiver device, the received spatial signatures (received wave fronts) resulting from transmissions from the two transmitter devices should be as close to orthogonal to each other as possible.

Regarding high received power, the precoders w₁ and w₂ should preferably be selected so that y₁=G₁w₁ and y₂=G₂w₂ are as large as possible (or, equivalently, so that

$${y}_{1}^{H} {y}_{1} and {y}_{2}^{H} {y}_{2}$$

are as large as possible).

Achieving both these aims simultaneously is oftentimes not possible; e.g., for propagation channel setups where the received wave front resulting from precoding with the strongest right singular vector of G₁ (which maximizes

$${y}_{1}^{H} {y}_{1} )$$

is not orthogonal to the received wave front resulting from precoding with the strongest right singular vector of G₂ (which maximizes

$${y}_{2}^{H} {y}_{2} ) .$$

To this end, this approach aims to maximize the received powers with the orthogonality as a constraint.

Assuming that M≥2, there exists (for any given vector w₁, say w′₁) at least one vector w₂ which minimizes the cost function J(w₁, w₂). More specifically, any vector w₂ in the null space of

$${w}_{1}^{′ H} {G}_{1}^{H} {G}_{2}$$

achieves J(w₁, w₂)=0. Since

$${w}_{1}^{′ H} {G}_{1}^{H} {G}_{2}$$

is a vector of dimension M×1, its nullspace has dimension M−1, so that a vector w₂ in the null space of

$${w}_{1}^{′ H} {G}_{1}^{H} {G}_{2}$$

can always be found when M≥2.

There is no compromise in terms of inter-steam orthogonality if the search for w₂ is constrained to a linear combination of two distinct basis vectors b₁ and b₂; i.e., w₂=[b₁c₁ b₂c₂].

Starting with assuming that

$${w}_{1} = {v}_{1}^{1}$$

(the right singular vector associated with the largest singular value of G₁; which maximizes the received power

$${y}_{1}^{H} {y}_{1} ) ,$$

and that

$${w}_{2} = [ {v}_{2}^{1} {c}_{1} {v}_{2}^{2} {c}_{2} ]$$

a linear combination of the two strongest right singular vectors of G₂), the orthogonality condition corresponds to finding ĉ=[c₁ c₂]^{T} such that

$${( {v}_{1}^{1} )}^{H} {G}_{1}^{H} {G}_{2} [ {v}_{2}^{1} {v}_{2}^{2} ] \hat{c} = 0 .$$

Then, using

$${w}_{2} = [ {v}_{2}^{1} {v}_{2}^{2} ] \hat{c}$$

maximizes the received power

$${y}_{2}^{H} {y}_{2}$$

under the constraints

$${w}_{1} = {v}_{1}^{1}$$

and J(w₁, w₂)=0.

The approach may be continued by repeating the search for the best setting of w₂ with one or more different assumptions for w₁; e.g.,

$${w}_{1} = [ {v}_{1}^{1} {a}_{1} {v}_{1}^{2} {a}_{2} ] .$$

For each assumption of w₁, the total rate (e.g., according to the previously mentioned expressions for total rate) for the resulting vector pair w₁, w₂ may be evaluated, and the pair of vectors that correspond to the highest rate may be selected.

For both Approaches A and B, it should be noted that any other suitable performance metric than total rate may be used for the evaluation that the selection is based on.

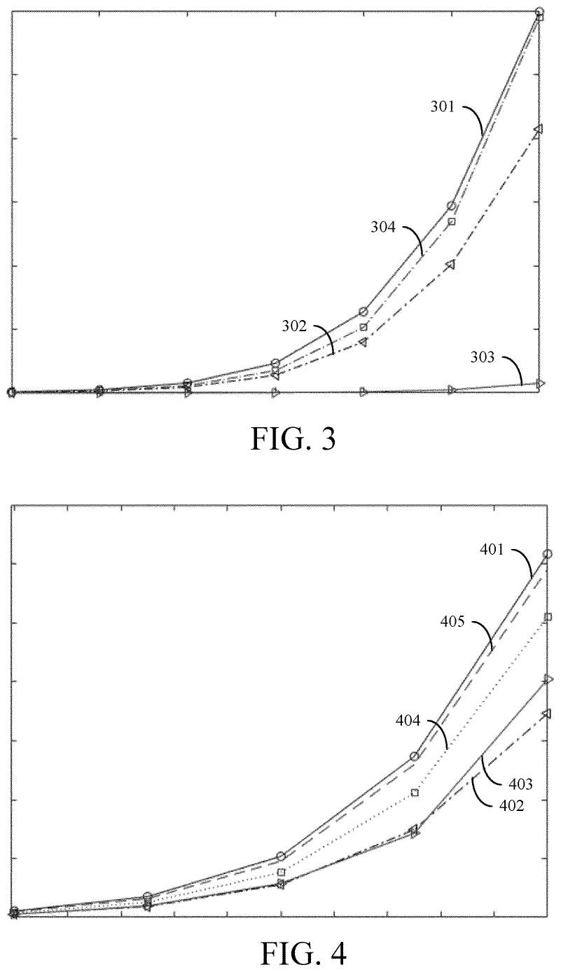

FIG. 3 illustrates example results achievable in a situation with two transmitter devices; corresponding the example scenario illustrated in FIG. 2.

The example results are shown in the form of spectral efficiency (expressed in bits/s/Hz on the y-axis; ranging from 0 to 3 bits/s/Hz) in dependence of normalized transmit power (expressed in dB on the x-axis; ranging from −40 to −10 dB).

The result of applying a solution with one data stream from each transmitter device (independently encoded) and the receiver device applies SIC (third benchmark) is illustrated by 301, and the result of applying a solution where only the best transmitter device is used for multi-stream transmission (second benchmark) is illustrated by 302.

The result of a solution with one data stream from each transmitter device, where each transmitter device applies a beamforming setting corresponding to the dominant right singular vector of its respective channel towards the receiver device (fourth benchmark), and the receiver device applies zero-forcing (ZF) decoding, is illustrated by 303.

The result of a solution with one data stream from each transmitter device, where each transmitter device applies a beamforming setting selected as suggested herein, and the receiver device applies zero-forcing (ZF) decoding, is illustrated by 304.

It can be noted that the suggested approach 304 outperforms the second and fourth benchmark approaches 302 and 303, and performs almost as well as the third benchmark approach 301. Furthermore, the SIC-approach 301 typically suffers from high complexity signal processing and/or error propagation.

It can also be noted that the fourth benchmark approach performs very poorly in the investigated scenario. This is due to that the incoming beamformed data streams at the receiver device are difficult to separate; the zero-forcing processing of the receiver device leads to noise amplification since H^{H} H is ill-conditioned.

FIG. 4 illustrates example results achievable in a situation with two transmitter devices; corresponding an example scenario with Rayleigh fading (the entries of the channels G₁ and G₂ are independently and identically distributed complex-valued circularly-symmetric zero-mean unit-variance Gaussian random variables). Investigating this channel model is interesting because it encompasses different types of channel setups, ranging from a type of channel setup where the strongest channel components are not well spatially separated at arrival (exemplified in FIG. 2) to a type of channel setup where the strongest channel components are very well spatially separated at arrival (e.g., close to orthogonal).

The example results are shown in the form of spectral efficiency (expressed in bits/s/Hz on the y-axis; ranging from 0 to 3.5 bits/s/Hz) in dependence of normalized transmit power (expressed in dB on the x-axis; ranging from −30 to −10 dB).

The result of applying a solution with one data stream from each transmitter device (independently encoded) and the receiver device applies SIC (third benchmark) is illustrated by 401, and the result of applying a solution where only the best transmitter device is used for multi-stream transmission (second benchmark) is illustrated by 402.

The result of a solution with one data stream from each transmitter device, where each transmitter device applies a beamforming setting corresponding to the dominant right singular vector of its respective channel towards the receiver device (fourth benchmark), and the receiver device applies zero-forcing (ZF) decoding, is illustrated by 403.

The result of a solution with one data stream from each transmitter device, where each transmitter device applies a beamforming setting selected as suggested herein, and the receiver device applies zero-forcing (ZF) decoding, is illustrated by 404 and 405 (corresponding to approach A and B, respectively).

It can be noted that the suggested approach 404, 405 outperforms the second and fourth benchmark approaches 402 and 403, and performs almost as well as the third benchmark approach 401. Furthermore, the SIC-approach 401 typically suffers from high complexity signal processing and/or error propagation.

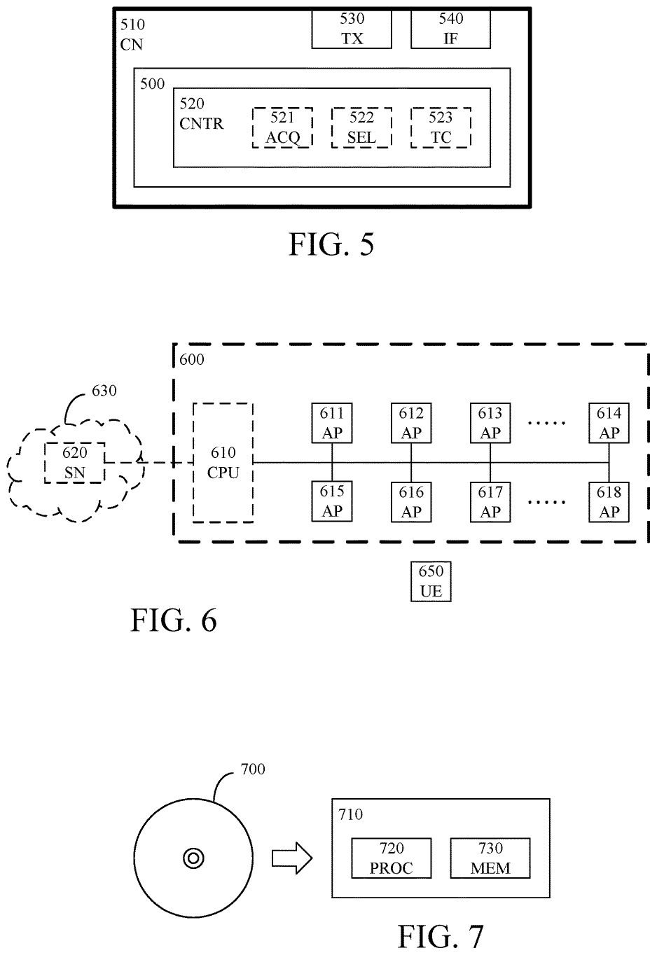

FIG. 5 schematically illustrates an example apparatus 500 according to some embodiments. The apparatus 500 is for controlling MIMO transmission to a receiver device from two or more non-phase aligned transmitter devices. For example, the apparatus 500 may be configured to perform, or cause performance of, one or more of the method steps as described in connection with FIG. 1. Alternatively or additionally, the apparatus may be comprised, or comprisable, in a control node (CN) 510; e.g., a control node for a D-MIMO system.

The apparatus comprises a controller (CNTR; e.g., controlling circuitry or a control module) 520.

The controller 520 may be configured to cause acquisition of channel information including information indicative of the respective channels form the transmitter devices towards the receiver device (compare with step 110 of FIG. 1).

To this end, the controller 520 may comprise or be otherwise associated with (e.g., connected, or connectable, to) an acquirer (ACQ; e.g., acquiring circuitry or an acquisition module) 521. The acquirer 521 may be configured to acquire the channel information in any suitable way; e.g., performing channel measurements and/or channel estimation based on received reference signaling, or receiving the channel information from another device.

The controller 520 is configured to cause selection of a respective beamforming setting for each of the transmitter devices (compare with step 120 of FIG. 1), wherein the selection is conditioned on a metric of spatial separation among the respective beamforming settings as affected by the respective channels.

To this end, the controller 520 may comprise or be otherwise associated with (e.g., connected, or connectable, to) a selector (SEL; e.g., selecting circuitry or a selection module) 522. The selector 522 may be configured to select the respective beamforming setting for each of the transmitter devices conditioned on the metric of spatial separation.

The controller 520 is also configured to cause the transmitter devices to transmit respective data streams to the receiver device using the selected respective beamforming setting (compare with step 130 of FIG. 1).

To this end, the controller 520 may comprise or be otherwise associated with (e.g., connected, or connectable, to) a transmission controller (TC; e.g., transmission controlling circuitry or a transmission control module) 523. The transmission controller 523 may be configured to control the transmitter devices to transmit the respective data streams using the selected respective beamforming setting.

For a transmitter device (TX; e.g., transmitting circuitry or a transmission module) 530 comprised in the control node 510, the transmission controller 523 may be configured to transmit the respective data stream(s) from that transmitter device 530 using the selected respective beamforming setting. For a transmitter device which is separate from the control node 510, the transmission controller 523 may be configured to transmit control signaling to the transmitter device via an interface (IF; e.g., interfacing circuitry or an interface module) 540, wherein the control signaling is configured to cause the transmitter device to transmit the respective data stream(s) of the transmitter device using the selected respective beamforming setting.

FIG. 6 schematically illustrates an example D-MIMO system 600 according to some embodiments. The D-MIMO system 600 comprises a central processing unit (CPU) 610 and a plurality of access points (AP) 611-618, and is configured to perform MIMO transmission to a user equipment (UE) 650.

In the context of the approaches described herein, the APs 611-618 may be seen as transmission devices, the UE 650 may be seen as a receiver device, and the CPU 610 may be seen as a control node (compare with the control node 510 of FIG. 5).

Thus, the CPU 610 may be configured to select a respective beamforming setting for each of the transmitter devices (compare with step 120 of FIG. 1), wherein the selection is conditioned on a metric of spatial separation among the respective beamforming settings as affected by the respective channels.

Alternatively, the selection of the respective beamforming settings conditioned on the metric of spatial separation may be performed remotely from the D-MIMO system 600, e.g., in a server node (SN) 620 configured for cloud 630 computations.

Generally, it should be noted that features and advantages described in connection with one of the Figures herein, are, when suitable, equally applicable-mutatis mutandis—to any of the other Figures; even if not explicitly mention in connection thereto.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an electronic apparatus, such as a control node for a distributed antenna system (e.g., a D-MIMO system).

Embodiments may appear within an electronic apparatus (such as a control node for a distributed antenna system) comprising arrangements, circuitry, and/or logic according to any of the embodiments described herein. Alternatively or additionally, an electronic apparatus (such as a control node for a distributed antenna system) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 7 illustrates an example computer readable medium in the form of a compact disc (CD) ROM 700. The computer readable medium has stored thereon a computer program comprising program instructions. The computer program is loadable into a data processor (PROC; e.g., a data processing unit) 720, which may, for example, be comprised in a control node 710 for a distributed antenna system. When loaded into the data processor, the computer program may be stored in a memory (MEM) 730 associated with, or comprised in, the data processor. According to some embodiments, the computer program may, when loaded into, and run by, the data processor, cause execution of method steps according to, for example, the method illustrated in FIG. 1, or otherwise described herein.

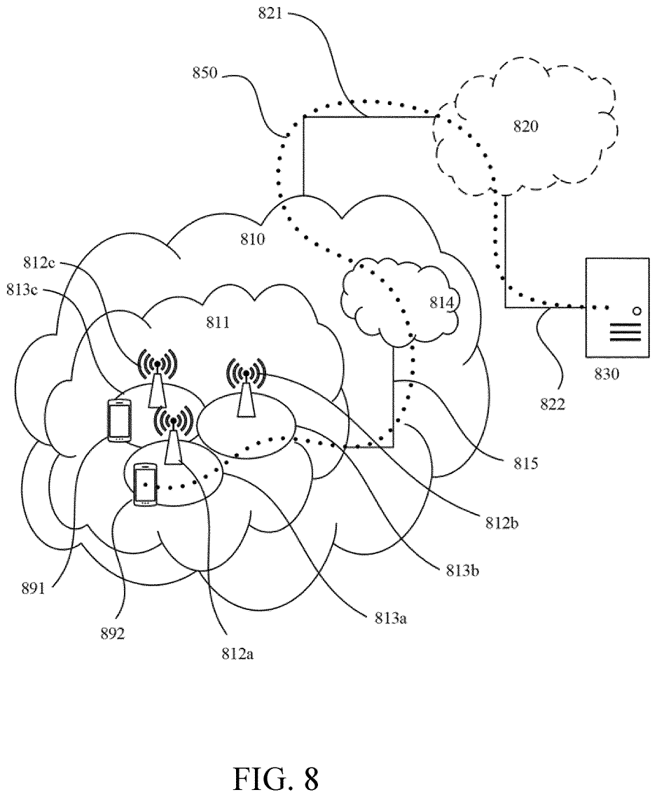

With reference to FIG. 8, in accordance with an embodiment, a communication system includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first user equipment (UE) 891 located in coverage area 813c is configured to wirelessly connect to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

One or more of the base stations 812a, 812b, 812c may represent a distributed antenna system. For example, a base station 812 may—in fact—represent a D-MIMO system comprising a plurality of transmitter devices and a control unit configured to operate as disclosed herein. Alternatively or additionally, two or more of the base stations 812a, 812b, 812c may be seen as transmitter devices, and a control unit configured to operate as disclosed herein may be comprised in one of the base stations 812a, 812b, 812c or otherwise in the network.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. The connections 821, 822 between the telecommunication network 810 and the host computer 830 may extend directly from the core network 814 to the host computer 830 or may go via an optional intermediate network 820. The intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system of FIG. 8 as a whole enables connectivity between one of the connected UEs 891, 892 and the host computer 830. The connectivity may be described as an over-the-top (OTT) connection 850. The host computer 830 and the connected UEs 891, 892 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, a base station 812 may not or need not be informed about the past routing of an incoming downlink communication with data originating from a host computer 830 to be forwarded (e.g., handed over) to a connected UE 891. Similarly, the base station 812 need not be aware of the future routing of an outgoing uplink communication originating from the UE 891 towards the host computer 830.

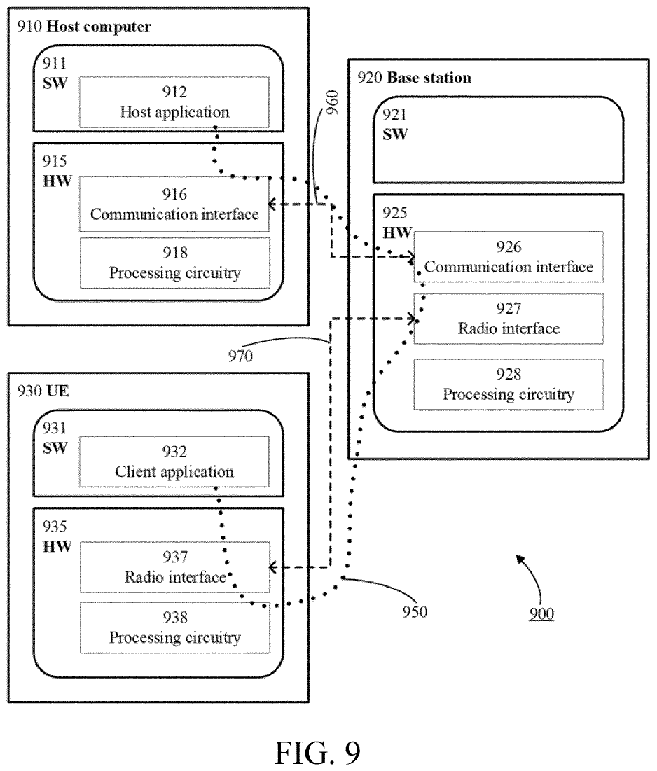

Example implementations, in accordance with an embodiment, of the UE, base station and host computer discussed in the preceding paragraphs will now be described with reference to FIG. 9. In a communication system 900, a host computer 910 comprises hardware 915 including a communication interface 916 configured to set up and maintain a wired or wireless connection with an interface of a different communication device of the communication system 900. The host computer 910 further comprises processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 910 further comprises software 911, which is stored in or accessible by the host computer 910 and executable by the processing circuitry 918. The software 911 includes a host application 912. The host application 912 may be operable to provide a service to a remote user, such as a UE 930 connecting via an OTT connection 950 terminating at the UE 930 and the host computer 910. In providing the service to the remote user, the host application 912 may provide user data which is transmitted using the OTT connection 950.

The communication system 900 further includes a base station 920 provided in a telecommunication system and comprising hardware 925 enabling it to communicate with the host computer 910 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with a UE 930 located in a coverage area (not shown in FIG. 9) served by the base station 920. The communication interface 926 may be configured to facilitate a connection 960 to the host computer 910. The connection 960 may be direct or it may pass through a core network (not shown in FIG. 9) of the telecommunication system and/or through one or more intermediate networks outside the telecommunication system. In the embodiment shown, the hardware 925 of the base station 920 further includes processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 910. In the host computer 910, an executing host application 912 may communicate with the executing client application 932 via the OTT connection 950 terminating at the UE 930 and the host computer 910. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 910, base station 920 and UE 930 illustrated in FIG. 9 may be identical to the host computer 830, one of the base stations 812a, 812b, 812c and one of the UEs 891, 892 of FIG. 8, respectively. This is to say, the inner workings of these entities may be as shown in FIG. 9 and independently, the surrounding network topology may be that of FIG. 8.

In FIG. 9, the OTT connection 950 has been drawn abstractly to illustrate the communication between the host computer 910 and the use equipment 930 via the base station 920, without explicit reference to any intermediary devices and the precise routing of messages via these devices. Network infrastructure may determine the routing, which it may be configured to hide from the UE 930 or from the service provider operating the host computer 910, or both. While the OTT connection 950 is active, the network infrastructure may further take decisions by which it dynamically changes the routing (e.g., on the basis of load balancing consideration or reconfiguration of the network).

The wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may improve communication performance (e.g., throughput), and thereby provide benefits such as reduced user waiting time. Alternatively or additionally, the teachings of these embodiments may improve power consumption of the receiver device, and thereby provide benefits such as extended battery lifetime.

A measurement procedure may be provided for the purpose of monitoring data rate, latency and other factors on which the one or more embodiments improve. There may further be an optional network functionality for reconfiguring the OTT connection 950 between the host computer 910 and UE 930, in response to variations in the measurement results. The measurement procedure and/or the network functionality for reconfiguring the OTT connection 950 may be implemented in the software 911 of the host computer 910 or in the software 931 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer's 910 measurements of throughput, propagation times, latency and the like. The measurements may be implemented in that the software 911, 931 causes messages to be transmitted, in particular empty or ‘dummy’ messages, using the OTT connection 950 while it monitors propagation times, errors etc.

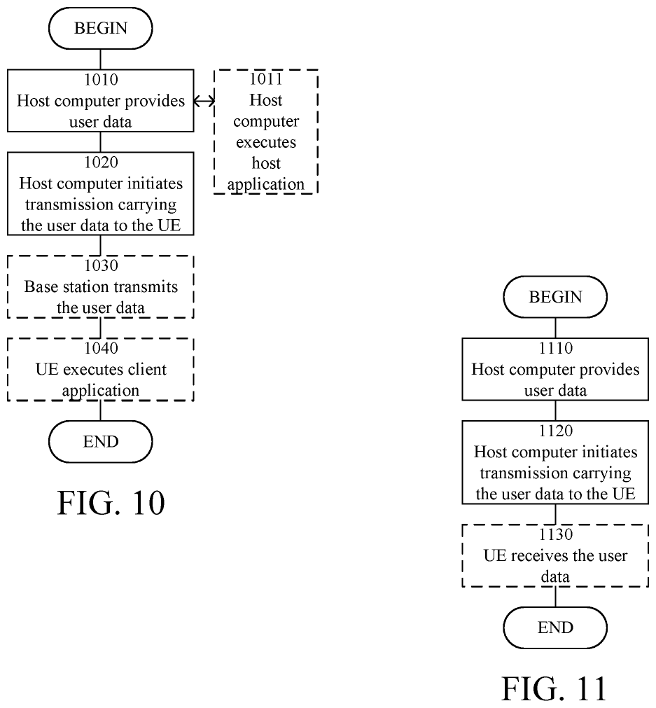

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section.

In a first step 1010 of the method, the host computer provides user data. In an optional substep 1011 of the first step 1010, the host computer provides the user data by executing a host application. In a second step 1020, the host computer initiates a transmission carrying the user data to the UE. In an optional third step 1030, the base station transmits to the UE the user data which was carried in the transmission that the host computer initiated, in accordance with the teachings of the embodiments described throughout this disclosure. In an optional fourth step 1040, the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In a first step 1110 of the method, the host computer provides user data. In an optional substep (not shown) the host computer provides the user data by executing a host application. In a second step 1120, the host computer initiates a transmission carrying the user data to the UE. The transmission may pass via the base station, in accordance with the teachings of the embodiments described throughout this disclosure. In an optional third step 1130, the UE receives the user data carried in the transmission.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

### SOME NUMBERED EMBODIMENTS

1. A base station configured to communicate with a user equipment (UE), the base station comprising a radio interface and processing circuitry configured to control multiple-input multiple-output, MIMO, transmission to the UE from two or more non-phase aligned transmitter devices, wherein each transmitter device is associated with a respective channel towards the receiver device, the method comprising:
   selecting a respective beamforming setting for each of the transmitter devices, wherein the selection is conditioned on a metric of spatial separation among the respective beamforming settings as affected by the respective channels; and
   causing the transmitter devices to transmit respective data streams to the receiver device using the selected respective beamforming setting.
2. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to control multiple-input multiple-output, MIMO, transmission to the UE from two or more non-phase aligned transmitter devices, wherein each transmitter device is associated with a respective channel towards the receiver device, the method comprising:
   selecting a respective beamforming setting for each of the transmitter devices, wherein the selection is conditioned on a metric of spatial separation among the respective beamforming settings as affected by the respective channels; and
   causing the transmitter devices to transmit respective data streams to the receiver device using the selected respective beamforming setting.
3. The communication system of embodiment 2, further including the base station.
4. The communication system of embodiment 3, further including the UE, wherein the UE is configured to communicate with the base station.
5. The communication system of embodiment 4, wherein:
   the processing circuitry of the host computer is configured to execute a host application, thereby providing the user data; and
   the UE comprises processing circuitry configured to execute a client application associated with the host application.
6. A method implemented in a base station, comprising controlling multiple-input multiple-output, MIMO, transmission to the UE from two or more non-phase aligned transmitter devices, wherein each transmitter device is associated with a respective channel towards the receiver device, by:
   selecting a respective beamforming setting for each of the transmitter devices, wherein the selection is conditioned on a metric of spatial separation among the respective beamforming settings as affected by the respective channels; and
   causing the transmitter devices to transmit respective data streams to the receiver device using the selected respective beamforming setting.
7. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station controls multiple-input multiple-output, MIMO, transmission to the UE from two or more non-phase aligned transmitter devices, wherein each transmitter device is associated with a respective channel towards the receiver device, by:
   selecting a respective beamforming setting for each of the transmitter devices, wherein the selection is conditioned on a metric of spatial separation among the respective beamforming settings as affected by the respective channels; and causing the transmitter devices to transmit respective data streams to the receiver device using the selected respective beamforming setting.
8. The method of embodiment 7, further comprising:
   at the base station, transmitting the user data.
9. The method of embodiment 8, wherein the user data is provided at the host computer by executing a host application, the method further comprising:
   at the UE, executing a client application associated with the host application.

1. A method for controlling multiple-input multiple-output, MIMO, transmission to a receiver device from two or more non-phase aligned transmitter devices, wherein each transmitter device is associated with a respective channel towards the receiver device, the method comprising:
selecting a respective beamforming setting for each of the transmitter devices, wherein the selection is conditioned on a metric of spatial separation among the respective beamforming settings as affected by the respective channels; and
causing the transmitter devices to transmit respective data streams to the receiver device using the selected respective beamforming setting.

2. The method of claim 1, wherein the metric of spatial separation comprises an achievable communication rate for the respective beamforming settings as affected by the respective channels.

3. The method of claim 1, wherein the metric of spatial separation comprises a respective inner product—for a pair of two of the transmitter devices—between the respective beamforming settings as affected by the respective channels.

4. The method of claim 3, wherein the selection is conditioned on the respective inner product—for one or more pair of two of the transmitter devices—having an absolute value that is lower than, or equal to, a threshold for inner product.

5. The method of claim 1, wherein the selection is further conditioned on a respective power of the respective beamforming setting as affected by the respective channel.

6. The method of claim 5, wherein the selection is conditioned on the respective power—for one of the transmitter devices—being higher than a threshold for respective power.

7. The method of claim 1, wherein the selection comprises, for each of the transmitter devices:
determining a set of candidate beamforming settings; and
selecting the respective beamforming setting as one of the candidate beamforming settings, or as a linear combination of two or more of the candidate beamforming settings.

8. The method of claim 7, wherein the set of candidate beamforming settings comprises one or more of:
a specific number of beamforming settings;
beamforming settings capturing a total power that is larger than a threshold for total power; and
beamforming settings each capturing an individual power that is larger than a threshold for individual power.

9. The method of claim 7, wherein the set of candidate beamforming settings is selected from right singular vectors of a singular value decomposition of a matrix representation of the respective channel.

10. The method of claim 7, wherein selecting the respective beamforming settings comprises:
evaluating—for one or more pair of two of the transmitter devices—combinations of candidate beamforming settings based on the metric of spatial separation; and
selecting the respective beamforming settings based on the evaluation.

11. The method of claim 1, wherein the selection of the respective beamforming settings comprises a trade-off between spatial separation among the respective beamforming settings and power of the respective beamforming settings.

12. The method of claim 1, wherein each of the transmitter devices is comprised in an access point of a distributed MIMO, D-MIMO, system.

13. The method of claim 1, wherein selecting the respective beamforming settings conditioned on the metric of spatial separation is responsive to the two or more transmitter devices being less than a specific number of transmitter devices.

14. A computer program product comprising a non-transitory computer readable medium, having thereon a computer program comprising program instructions, the computer program being loadable into a data processing unit and configured to cause execution of the method according to claim 1 when the computer program is run by the data processing unit.

15. An apparatus for controlling multiple-input multiple-output, MIMO, transmission to a receiver device from two or more non-phase aligned transmitter devices, wherein each transmitter device is associated with a respective channel towards the receiver device, the apparatus comprising controlling circuitry configured to cause:
selection of a respective beamforming setting for each of the transmitter devices, wherein the selection is conditioned on a metric of spatial separation among the respective beamforming settings as affected by the respective channels; and
the transmitter devices to transmit respective data streams to the receiver device using the selected respective beamforming setting.

16. The apparatus of claim 15, wherein the metric of spatial separation comprises an achievable communication rate for the respective beamforming settings as affected by the respective channels.

17. The apparatus of claim 15, wherein the metric of spatial separation comprises a respective inner product—for a pair of two of the transmitter devices—between the respective beamforming settings as affected by the respective channels.

18.-26. (canceled)

27. A control node comprising an apparatus for controlling multiple-input multiple-output, MIMO, transmission to a receiver device from two or more non-phase aligned transmitter devices, wherein each transmitter device is associated with a respective channel towards the receiver device, the apparatus comprising controlling circuitry configured to cause:
selection of a respective beamforming setting for each of the transmitter devices, wherein the selection is conditioned on a metric of spatial separation among the respective beamforming settings as affected by the respective channels; and
the transmitter devices to transmit respective data streams to the receiver device using the selected respective beamforming setting.

28. A distributed MIMO, D-MIMO, system comprising a plurality of access points and the control node of claim 27.

29. The D-MIMO system of claim 28, wherein each of the transmitter devices is comprised in a respective one of the access points.
